(19) United States
(12) Patent Application Publication
(10) Pub. No.: US 2026/0321024 A1
(43) Pub. Date: Oct. 15, 2026

(54) DEVICE, METHOD AND NON-TRANSITORY COMPUTER READABLE STORAGE MEDIUM FOR ESTIMATING OCCUPANCY STATE OF SURROUNDING OBJECT IN THREE-DIMENSIONAL SPACE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Nobuaki MATSUDAIRA, Nisshin-shi (JP); Tomohiro NEZUKA, Nisshin-shi (JP)

(21) Appl. No.: 19/631,051

(22) Filed: Mar. 27, 2026

(30) Foreign Application Priority Data
Apr. 10, 2025 (JP) 2025-064904

(51) Int. Cl. G06V 20/58; G06T 17/05

(52) U.S. Cl. CPC G06V 20/58; G06T 17/05

(57) ABSTRACT

A device is mounted on a mobile body and estimates an occupancy state of a surrounding object in three-dimensional space. The mobile body has a camera that captures an image of surroundings of the mobile body and outputs two-dimensional image data. The device includes: a point group output unit that uses the two-dimensional image data to output the three-dimensional point group data of the surrounding object in the three-dimensional space by the Visual Odometry; and an occupancy state estimation unit that estimates the occupancy state by the Occupancy Prediction using the two-dimensional image data and the three-dimensional point group data.

### CROSS REFERENCE TO RELATED APPLICATION

The present application claims the benefit of priority from Japanese Patent Application No. 2025-064904 filed on Apr. 10, 2025. The entire disclosure of the above application is incorporated herein by reference.

### TECHNICAL FIELD

The present disclosure relates to a device, a method and a non-transitory computer readable storage medium for estimating an occupancy state of a surrounding object in three-dimensional space.

### BACKGROUND

Various techniques have been proposed for estimating the occupancy state of objects around a vehicle. For example, Patent Literature 1 teaches a technique for estimating an occupancy state using two-dimensional image data output by a camera and a machine learning model. Furthermore, Non-Patent Literature 1 teaches that the accuracy of estimating the occupancy state can be improved by using three-dimensional point group data acquired using a distance measurement sensor in addition to the two-dimensional image data.

### SUMMARY

According to an example, a device is mounted on a mobile body and estimates an occupancy state of a surrounding object in three-dimensional space. The mobile body has a camera that captures an image of surroundings of the mobile body and outputs two-dimensional image data. The device includes: at least one processor with a memory. The at least one processor with the memory may be configured to cause the device to execute: using the two-dimensional image data to output three-dimensional point group data of the surrounding object in the three-dimensional space by Visual Odometry; and estimating the occupancy state by occupancy prediction using the two-dimensional image data and the three-dimensional point group data.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a schematic configuration of a device according to an embodiment of the present disclosure;

FIG. 2 is an explanatory diagram showing an example of camera arrangement;

FIG. 3 is an explanatory diagram of coordinate conversion;

FIG. 4 is a diagram showing expressions (1) to (5); and

FIG. 5 is a flowchart showing the procedure of an occupancy state estimation process.

### DETAILED DESCRIPTION

However, using a distance measurement sensor as in Non-Patent Literature 1 increases costs. There is a need for technique that can improve the accuracy of estimating the occupancy state while reducing costs. This difficulty is not limited to vehicles but is common to any mobile object.

The present disclosure can be realized as the following embodiments.

According to one aspect of the present embodiments, a device is mounted on a mobile body and estimates an occupancy state of a surrounding object in three-dimensional space. The mobile body has a camera that captures an image of the surroundings of the mobile body and outputs two-dimensional image data. The device includes: a point group output unit that uses the two-dimensional image data to output three-dimensional point group data of the surrounding object in the three-dimensional space by Visual Odometry; and an occupancy state estimation unit that estimates the occupancy state by occupancy prediction using the two-dimensional image data and the three-dimensional point group data.

According to this feature of the device, the device includes: a point group output unit that uses the two-dimensional image data to output the three-dimensional point group data of the surrounding object in the three-dimensional space by the Visual Odometry; and an occupancy state estimation unit that estimates the occupancy state by the Occupancy Prediction using the two-dimensional image data and the three-dimensional point group data. Thus, compared to a configuration in which the occupancy prediction uses a distance measurement sensor such as LiDAR to acquire the three-dimensional point group data, the costs can be reduced. Furthermore, the estimation accuracy can be improved compared to a configuration that uses only the two-dimensional image data without using the three-dimensional point group data.

### A. First Embodiment

### Outline of Device 1

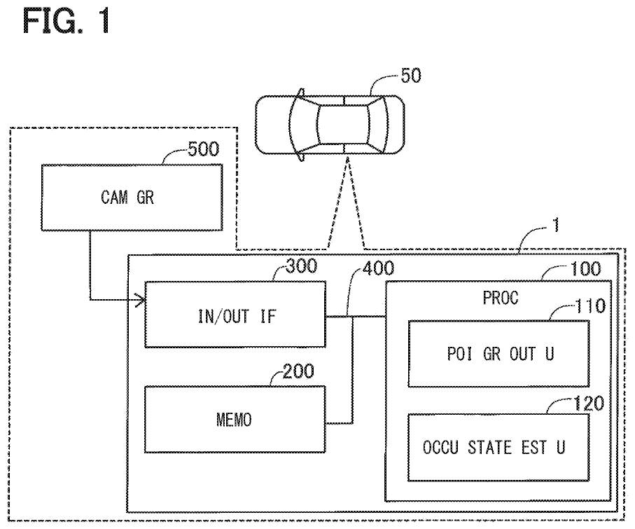

The device 1 shown in FIG. 1 is mounted on a vehicle 50. The device 1 estimates the occupancy state of a surrounding object around the vehicle 50 in three-dimensional space using two-dimensional image data of the surroundings of the vehicle 50. The two-dimensional image data is output from a group of cameras 500 mounted on a vehicle 50. The estimated occupancy state is used for drive support such as collision prediction of the vehicle 50. In addition, the estimated occupancy state is displayed on a display mounted on the vehicle 50 as information about the surroundings of the vehicle 50.

### Configuration of Camera Group 500

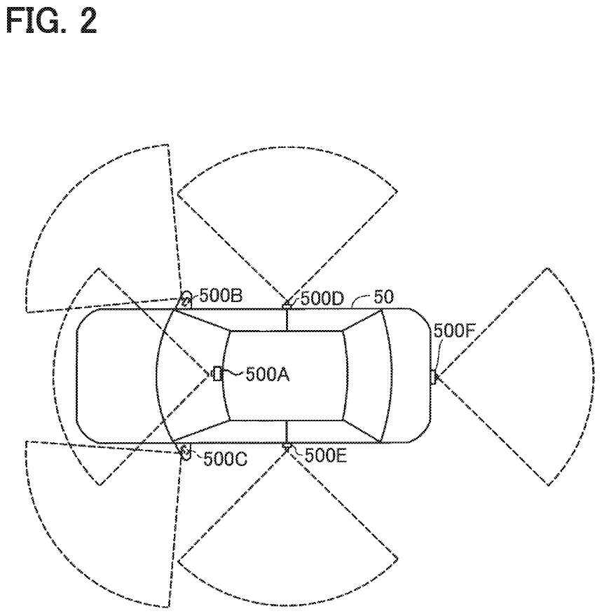

As shown in FIG. 2, the camera group 500 includes six cameras 500A, 500B, 500C, 500D, 500E, and 500F mounted on the vehicle 50. Each of the cameras 500A to 500F is a monocular camera that can output two-dimensional image data. The camera 500A is provided on an upper portion of the windshield of the vehicle 50. The camera 500A captures an image of a predetermined range in front of vehicle 50. The camera 500B is provided below the door mirror on the right side of the vehicle 50. Hereinafter, the right side of the vehicle 50 refers to the right side as seen by a person sitting inside the vehicle 50 facing the front side of the vehicle 50. The camera 500B captures an image of a predetermined range diagonally forward to the right of vehicle 50. The camera 500C is provided below the door mirror on the left side of the vehicle 50. The left side of the vehicle 50 refers to the left side as seen by a person sitting inside the vehicle 50 facing the front side of the vehicle 50. The camera 500C captures an image of a predetermined range diagonally forward and to the left of vehicle 50. The camera 500D is provided on the door pillar on the right side of the vehicle 50. The camera 500D captures an image of a predetermined range on the right side of vehicle 50. The camera 500E is provided on the door pillar on the left side of the vehicle 50. The camera 500E captures an image of a predetermined range on the left side of vehicle 50. The camera 500F is provided in the center of the back door. The camera 500F captures an image of a predetermined range behind vehicle 50.

Each of the cameras 500A to 500F captures an image of the surroundings of the vehicle 50 at a predetermined frame rate and outputs the two-dimensional image data to the device 1. The two-dimensional image data output by each of the cameras 500A to 500F is synchronized. In the following description, the cameras 500A to 500F may be simply referred to as “cameras” without distinction.

### Configuration of Device 1

The device 1 is configured as a computer including a processor 100, a memory 200, and an input/output interface 300. The processor 100, the memory 200, and the input/output interface 300 are connected to one another via an internal bus 400. The device 1 may be realized as part of an ECU (Electronic Control Unit) that controls the vehicle 50. The processor 100 executes a program stored in the memory 200 to realize the functions of a point group output unit 110 and an occupancy state estimation unit 120.

### Functions of the Point Group Output Unit 110

The point group output unit 110 uses the two-dimensional image data output by the camera group 500 to output three-dimensional point group data of the surrounding object around the vehicle 50 in the three-dimensional space using Visual Odometry (hereinafter referred to as “VO”). In the present embodiments, the three-dimensional point group data is a set of feature points extracted from the two-dimensional image data.

The VO is explained below. In the VO, the feature points are detected from multiple consecutive two-dimensional image data in a time series, and the coordinates of the detected feature points are used to estimate the three-dimensional coordinates of the feature points in the world coordinate system. It can be said that the VO converts the feature points in the two-dimensional image data into the feature points in the three-dimensional space.

A corner detection technique is used to detect the feature points in the two-dimensional image data. For example, the intersection of two edges is detected as a corner. Alternatively, a point where there are two distinct edges of different directions in a local neighborhood is detected as a corner. Examples of corner detection methods that can be used include Harris corner detection, scale-invariant feature transform (SHIFT), speeded up robust features (SURF), and oriented fast and rotated brief (ORB). Furthermore, many corner detection techniques can detect not only the corner points but also the feature points. The number of feature points detected from one piece of the two-dimensional image data is, for example, one hundred.

For example, the feature points are detected from three consecutive pieces of the two-dimensional image data taken by the same camera in time series. The times at which the three pieces of the two-dimensional image data are acquired are designated as times t0, t1, and t2. Time t0 is the earliest time, and time t2 is the latest time. The feature points of the two-dimensional image data acquired at times t0, t1, and t2 are detected, and the coordinates and brightness values of each detected feature point are recorded. The detected feature points are, for example, corners of buildings, outlines of traffic signs, color boundaries of traffic signs, corners of curbs.

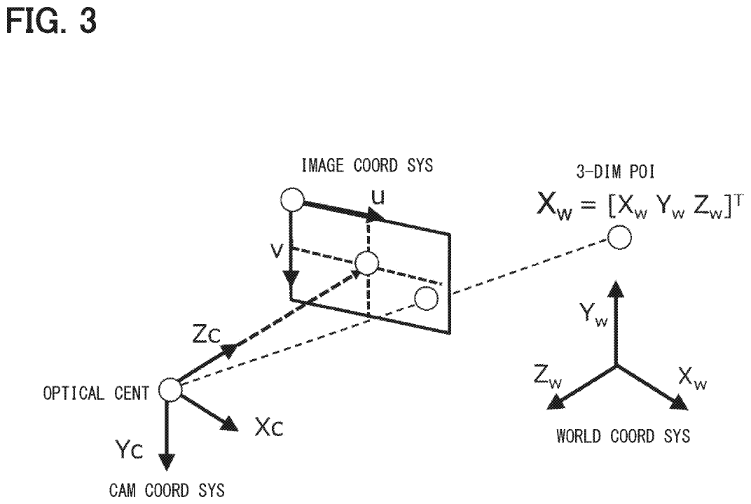

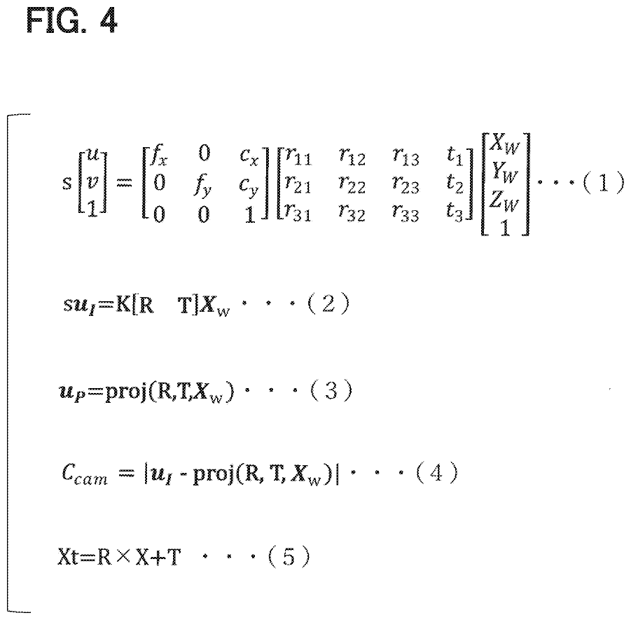

As shown in FIG. 3, the coordinates of the detected feature points are acquired by projecting the three-dimensional positions of the object in the world coordinate system onto the image coordinate system. The relationship between the coordinates of the feature points in the two-dimensional image data and the three-dimensional positions of the feature points in the world coordinate system can be expressed as in expression (1) shown in FIG. 4. In the expression (1), fₓ and f_{y} represent focal lengths. In the expression (1), cₓ and c_{y} represent the positions of the intersections of the optical axis and the projection plane. In the expression (1), r₁₁ to r₃₃ represent rotation matrices. In the expression (1), t₁ to t₃ represent translation vectors. In the expression (1), s represents the scale factor. The scale factor s is estimated using the results of measuring the position and attitude of the camera in advance.

As shown in FIG. 4, the expression (1) can be expressed in the form of the expression (2). The matrix K in expression (2) is called the internal parameter of the camera. The matrix [R T] is called the external parameter of the camera. The external parameter of the camera is determined by the position T and attitude R in the camera coordinate system. As shown in expression (2), the position of “u_{I}=[u v 1]^{T} in the two-dimensional image data is expressed as a function of the position T and the attitude R in the camera coordinate system and the position of “X_{w}=[Xw Yw Zw]^{T} in the world coordinate system.

When tracking the positions of feature points corresponding to the same object detected in multiple pieces of the two dimensional image data consecutively acquired in the time series, the position of the feature point being focused on changes as the vehicle 50, i.e., the camera group 500, moves.

In the VO, the position and attitude of the camera and the three-dimensional coordinates of the feature points in the world coordinate system at time t1 are estimated based on the positions of the feature points detected in each two-dimensional image data by bundle adjustment. Specifically, the coordinates of corresponding feature points detected in multiple pieces of the two-dimensional image data and the assumed camera position T and attitude R are used to calculate the camera position and attitude and the three-dimensional coordinates of the feature points in the world coordinate system at time t1. The calculated three-dimensional coordinates are then re-projected onto the image coordinate system, and the distance (i.e., re-projection error) between the projected point and the feature point detected from the two-dimensional image data is estimated.

The position of the feature point in the two-dimensional image data can be acquired by a projection function as shown in expression (3) in FIG. 4. It is assumed that the internal parameters are fixed, and the internal parameters are not taken into consideration in expression (3). The projection function is a function that maps the coordinate system of the object space (i.e., the world coordinate system) to the coordinate system of the image space (i.e., the image coordinate system).

The error between the position u_{I} of the feature point detected from the two-dimensional image data and the position u_{P} of the feature point determined by the projection function is defined as shown in expression (4) in FIG. 4. In expression (4), u_{I} represents a set of coordinates of feature points detected from the two-dimensional image data.

By performing optimization processing to minimize the error function C_{cam} expressed in expression (4), the three-dimensional coordinates of the feature points in the world coordinate system and the position and attitude of the camera at time t1 are estimated. The estimated three-dimensional coordinates of the feature points in the world coordinate system are the three-dimensional coordinates of the feature points in the two-dimensional image data acquired at time t1. The estimated camera position and attitude are expressed as a rotation matrix and a translation vector. Minimizing the error expressed in expression (4) means minimizing the error between the actual coordinates of the detected feature points in the image and the coordinates of the feature points calculated by the projection function. In this way, in the VO, the feature points of an object in the two-dimensional image data are converted into feature points in the three-dimensional space, and the three-dimensional point group data is output as a set of feature points in the three-dimensional space.

### Functions of the Occupancy State Estimation Unit 120

The occupancy state estimation unit 120 shown in FIG. 1 uses the two-dimensional image data and the feature points output by the point group output unit 110 to estimate the occupancy state of an object in the three-dimensional space using the Occupancy Prediction (hereinafter referred to as “OP”). The OP in the embodiments is a method for estimating the occupancy state of an object in the three-dimensional space by combining the feature amount of the object acquired from the two-dimensional image data with information about the object acquired from the three-dimensional point group data. In this embodiment, the occupancy information of the object in the three-dimensional space is estimated by using the three-dimensional point group data acquired by the VO in the method disclosed in “A survey on occupancy perception for autonomous driving: The information fusion perspective”, Huaiyuan Xu, Junliang Chen, Shiyu Meng, Yi Wang, and Lap-Pui Chau, arXiv preprint arXiv: 2405.05173, 2024.

The document of “A survey on occupancy perception for autonomous driving: The information fusion perspective” is incorporated herein by reference. The OP executed by the occupancy state estimation unit 120 in this embodiment will be described below.

The occupancy state estimation unit 120 extracts two-dimensional feature amounts using the two-dimensional image data output from the camera group 500. The two-dimensional feature amount can be acquired, for example, by using a convolutional neural network with the two-dimensional image data as input. The extraction may be performed using any machine learning model that receives the two-dimensional image data as input and outputs the two-dimensional feature amounts. Next, the occupancy state estimation unit 120 converts the two-dimensional feature amount into a three-dimensional feature amount. The conversion is performed by a geometry-based method, such as inverse projection. In the inverse projection, the internal parameters of the camera stored in advance in the memory 200 are used. The conversion may also be performed using any machine learning model that receives the two-dimensional feature amounts as input and outputs the three-dimensional feature amounts.

The occupancy state estimation unit 120 extracts the three-dimensional feature amounts using the three-dimensional point group data output by the point group output unit 110. The three-dimensional feature amount extracted here is different from the three-dimensional feature amount extracted from the two-dimensional feature amount described above. The three-dimensional point group data is pre-processed by voxelization. The three-dimensional feature amount can be acquired, for example, by using a three-dimensional convolutional neural network with voxelized three-dimensional point group data as input. The three-dimensional feature amount may be extracted by using any machine learning model that receives the three-dimensional point group data as input and outputs the three-dimensional feature amount.

The occupancy state estimation unit 120 integrates the three-dimensional feature amount acquired from the two-dimensional image data and the three-dimensional feature amount acquired from the three-dimensional point group data. The integration can be performed using, for example, the channel connection method disclosed in “Occfusion: A straightforward and effective multi-sensor fusion framework for 3D occupancy prediction,” Z. Ming, J. S. Berrio, M. Shan, and S. Worrall, arXiv: 2403.01644, 2024, or the weighted sum method disclosed in “Open Occupancy: A large-scale benchmark for surrounding semantic occupancy perception,” X. Wang, Z. Zhu, W. Xu, Y. Zhang, Y. Wei, X. Chi, Y. Ye, D. Du, J. Lu, and X. Wang, in: Proceedings of the IEEE/CVF International Conference on Computer Vision, 2023, pp. 17850-17859, or the cross-attention method disclosed in “Unleashing hydra: Hybrid fusion, depth consistency and radar for unified 3d perception”, P. Wolters, J. Gilg, T. Teepe, F. Herzog, A. Laouichi, M. and Hofmann, G, arXiv: 2403.07746, 2024.

The document of “Occfusion: A straightforward and effective multi-sensor fusion framework for 3D occupancy prediction”, the document of “Open Occupancy: A large-scale benchmark for surrounding semantic occupancy perception” and the document of “Unleashing hydra: Hybrid fusion, depth consistency and radar for unified 3d perception” are incorporated herein by reference. The integration is not limited to these methods and may be realized by any other method.

The occupancy state estimation unit 120 estimates the occupancy information of the object based on the integrated three-dimensional feature amount. The occupancy information of the object includes information about the area that the object occupies in the three-dimensional space and information about the type of object. More specifically, the occupancy state estimation unit 120 divides the three-dimensional space into discrete cells or voxels, and estimates what object occupies each cell or voxel. The estimation is performed using a machine learning model that inputs the integrated three dimensional features and outputs the occupancy information. The estimation results include, for example, the presence or absence of an object in each cell or voxel and the type of object.

### Occupancy State Estimation Process

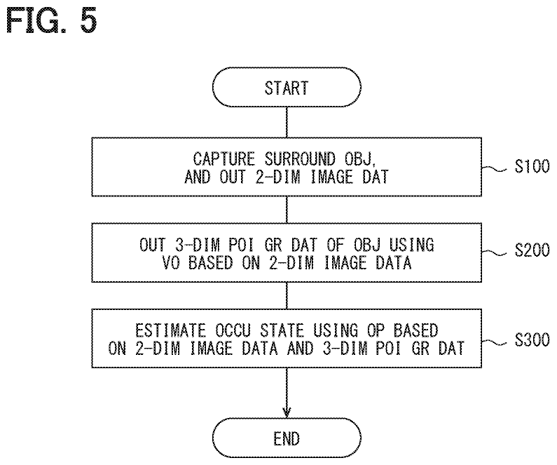

The occupancy state estimation process shown in FIG. 5 is performed to estimate the occupancy state in the three-dimensional space around the vehicle 50. The estimation process is repeatedly performed while the vehicle 50 is traveling.

The camera group 500 captures an image of an object around the vehicle 50 and outputs the two-dimensional image data (at step S100). The point group output unit 110 uses the two-dimensional image data output in step S100 to output the three-dimensional point group data of the object by the VO (at step S200). The occupancy state estimation unit 120 estimates the occupancy state by the OP using the two-dimensional image data output in step S100 and the three-dimensional point group data output in step S200 (at step S300).

The device 1 of the first embodiment described above is equipped with a point group output unit 110 that uses the two-dimensional image data to output the three-dimensional point group data of an object in the three-dimensional space by the VO, and an occupancy state estimation unit 120 that uses the two-dimensional image data and the three-dimensional point group data to estimate the occupancy state by the OP. Therefore, the occupancy state of the object can be estimated at lower cost than a configuration in which the three-dimensional point group data is used in the OP using a distance measurement device such as LiDAR. Furthermore, the estimation accuracy can be improved compared to a configuration in which the occupancy state is estimated using only the two-dimensional image data without using the three-dimensional point group data.

### B. Second Embodiment

The device 1 of the second embodiment differs from the device 1 of the first embodiment in that the point group output unit 110 outputs the three-dimensional point group data by further using the measurement results of the inertial measurement device. The configuration of the device 1 of the second embodiment that is not specifically described below is the same as that of the device 1 of the first embodiment.

The inertial measurement device is mounted on the vehicle 50 and outputs one of the angle, angular velocity, and acceleration of the vehicle 50. The point group output unit 110 in this embodiment further uses at least one of the output angle, angular velocity, and acceleration to output the three-dimensional point group data using Visual Inertial Odometry (hereinafter referred to as “VIO”). The VIO is one type of the VO. The VIO is a method for estimating the attitude or position of the camera group 500 using the output of an inertial measurement device. Specifically, the amount of movement and amount of rotation of the camera group 500 in a predetermined time interval is calculated using at least one of the angle, angular velocity, and acceleration output by the inertial measurement device. The amount of movement and the amount of rotation are used to estimate the attitude and position of the camera group 500. The estimated camera attitude and position are used as the camera position T and attitude R in the above-mentioned VO. As the VIO, for example, the method disclosed in “A robust and versatile monocular visual-inertial state estimator”, Tong, Q., Peiliang, L., Shaojie, and S. VINS-Mono, IEEE Trans. Robot. PP (99), 1-17, 2017 can be used.

The document of “A robust and versatile monocular visual-inertial state estimator” is incorporated herein by reference.

According to the second embodiment of the device 1 described above, the point group output unit 110 further uses at least one of the output angle, angular velocity, and acceleration to output the three-dimensional point group data by the VIO, thereby making it possible to acquire the three-dimensional point group data with higher accuracy. This improves the accuracy of estimating the occupancy state of the object.

### C. Third Embodiment

The device 1 of the third embodiment differs from the device 1 of the second embodiment in that the point group output unit 110 further uses the wheel speed of the vehicle 50 to output the three-dimensional point group data. The configuration of the device 1 of the third embodiment that is not specifically described below is the same as that of the device 1 of the second embodiment.

The wheel speed is output by a wheel speed sensor mounted on the vehicle 50. The wheel speed is output at a predetermined cycle. The point group output unit 110 further uses the output wheel speed to output the three-dimensional point group data by Visual Inertial Wheel Odometry (hereinafter referred to as “VIWO”). The VIWO is one type of the VO. The VIWO is a method for improving the accuracy of the VIO described in the second embodiment by using the output of a wheel speed sensor. The inertial measurement device may have a possibility to generate a drift that is a phenomenon in which errors accumulate. Furthermore, the inertial measurement device cannot measure the actual travel distance of the vehicle 50. As a result, the results output by the inertial measurement device may include errors. If a value including such an error is used for the VIO, there is a possibility that the accuracy of the output three-dimensional point group data will decrease. To reduce such errors, the position and attitude of the camera are corrected using the wheel speed measured by the wheel speed sensor. More specifically, the camera position and attitude are corrected using the camera travel distance calculated using the wheel speed and wheel radius. The corrected camera attitude and position are used as the camera position T and attitude R in the VIO described above. As the VIWO, for example, the method disclosed in “VIW-Fusion: Extrinsic Calibration and Pose Estimation for Visual-IMU-Wheel Encoder System,” C. Qiao, S. Zhao, Y. Zhang, Y. Wang and D. Zhang, 2023 IEEE/RSJ International Conference on Intelligent Robots and Systems (IROS), Detroit, MI, USA, 2023, pp. 1489-1496, doi: 10.1109/IROS 55552.2023.10341453, 2023 can be used.

The document of “VIW-Fusion: Extrinsic Calibration and Pose Estimation for Visual-IMU-Wheel Encoder System” is incorporated herein by reference.

According to the device 1 of the third embodiment described above, the point group output unit 110 further uses the wheel speed to output the three-dimensional point group data by the VIWO, thereby suppressing a decrease in the accuracy of the three-dimensional point group data compared to a configuration that outputs the three-dimensional point group data without using the wheel speed.

### D. Fourth Embodiment

The device 1 of the fourth embodiment differs from the device 1 of the second embodiment in that the point group output unit 110 further uses position information relating to the position of the vehicle 50 to output the three-dimensional point group data. The configuration of the device 1 of the fourth embodiment that is not specifically described below is the same as that of the device 1 of the second embodiment. The device 1 of the fourth embodiment may be used in combination with the device 1 of the third embodiment.

The position information is output at a predetermined interval by a Global Navigation Satellite System (hereinafter referred to as “GNSS”) mounted on the vehicle 50. The point group output unit 110 further uses the output position information to output the three-dimensional point group data using GNSS-Aided Visual Inertial Odometry (hereinafter referred to as “GVIO”). The GVIO is one type of the VO. The GVIO is a method for improving the accuracy of the VIO described in the second embodiment by using the position information. The position information is output by the GNSS at a predetermined cycle, and by using this position information, the position and attitude of the camera can be detected over time. The point group output unit 110 uses the position and attitude detected over time as the position T and attitude R of the camera in the VIO described above, and outputs the three-dimensional point cloud data. Here, the GNSS may not be available in areas with many obstructions. In such a case, the three-dimensional point group data is output by the VIO using the output results from the inertial measurement device. As the GVIO, for example, the method disclosed in “G-VIDO: A Vehicle Dynamics and Intermittent GNSS-Aided Visual-Inertial State Estimator for Autonomous Driving,” L. Xiong et al., IEEE Transactions on Intelligent Transportation Systems, vol. 23, no. 8, pp. 11845-11861, August 2022, doi: 10.1109/TITS. 2021.3107873, 2021 can be used.

The document of “G-VIDO: A Vehicle Dynamics and Intermittent GNSS-Aided Visual-Inertial State Estimator for Autonomous Driving” is incorporated herein by reference.

According to the device 1 of the fourth embodiment described above, the point group output unit 110 further uses the position information to output the three-dimensional point group data using the GVIO, thereby improving the accuracy of the three-dimensional point group data compared to a configuration that outputs the three-dimensional point group data without using the position information.

### E. Fifth Embodiment

The device 1 of the fifth embodiment differs from the device 1 of the fourth embodiment in that the occupancy state estimation unit 120 estimates the occupancy state by further using map feature amounts. The configuration of the device 1 of the fifth embodiment that is not specifically described below is the same as that of the device 1 of the fourth embodiment.

The map feature amount is extracted using map information. The map information is stored in advance in the memory 200. The occupancy state estimation unit 120 extracts the map feature amount from the map information relating to the surroundings of the vehicle 50 using the GNSS and the map information. The extraction is performed using, for example, a convolutional neural network. The map feature amount may be output by using any machine learning model that receives the map information as input and outputs the map feature amount. The map feature amounts include numerical representations of the locations, directions, connections, shape patterns, and the like of roads and buildings included in the map information. The occupancy state estimation unit 120 further integrates the map feature amounts in addition to the three-dimensional feature amounts acquired from the two-dimensional image data and the three-dimensional feature amounts acquired from the three-dimensional point group data. The occupancy state estimation unit 120 estimates the occupancy state using the integrated feature amount. As a method using the map feature amounts, for example, the method disclosed in “P-mapnet: Far-seeing map generator enhanced by both SDMap and HDMap priors”, Zhou Jiang, Zhenxin Zhu, Pengfei Li, Huan-ang Gao, Tianyuan Yuan, Yongliang Shi, Hang Zhao, and Hao Zhao, arXiv preprint arXiv: 2403.1052, 2024 can be used.

The document of “P-mapnet: Far-seeing map generator enhanced by both SDMap and HDMap priors” is incorporated herein by reference.

According to the fifth embodiment of the device 1 described above, the occupancy state estimation unit 120 estimates the occupancy state by further using the map feature amounts extracted from the map information, thereby further improving the accuracy of estimating the occupancy state compared to a configuration that estimates the occupancy state without using the map feature amounts.

### F. Sixth Embodiment

The device 1 of the sixth embodiment differs from the device 1 of the first embodiment in that the occupancy state estimation unit 120 estimates the occupancy state using feature amounts corrected by Temporal Fusion. The configuration of the device 1 of the sixth embodiment that is not specifically described below is the same as that of the device 1 of the first embodiment. The device 1 of the sixth embodiment may be used in combination with the device 1 of the second to fifth embodiments.

The occupancy state estimation unit 120 corrects the three-dimensional feature amount extracted from the three-dimensional point group data using the Temporal Fusion. The Temporal Fusion is a method to correct information acquired from past three dimensional feature amounts to current three dimensional feature amounts and improve the accuracy of occupancy state estimation using the corrected three dimensional feature amounts. Specifically, in the Temporal Fusion, past three dimensional feature amounts are corrected by the amount of change in the camera position and attitude, and the three dimensional feature amounts corrected to the current viewpoint are output. The changes in the position and attitude of the camera can be estimated using, for example, the VIO described in the second embodiment. The correction is performed, for example, by using expression (5) shown in FIG. 4. In expression (5), Xₜ is the feature amount at the current time t, Xₜ₋₁ is the feature amount at the time (t−1) before the current time t, R is the rotation of the camera from time (t−1) to time t, and T is the movement of the camera from time (t−1) to time t. The corrected feature amount is integrated with the current feature amount. The integration is performed by any method, such as connection fusion, additive fusion, or cross-attention fusion. The integration can also be performed using the method disclosed in “PanoOcc: Unified occupancy representation for camera-based 3D panoptic segmentation”, Y. Wang, Y. Chen, X. Liao, L. Fan, and Z. Zhang, arXiv: 2306.10013, 2023.

The document of “PanoOcc: Unified occupancy representation for camera-based 3D panoptic segmentation” is incorporated herein by reference. The integrated feature amount is further integrated with the three-dimensional feature amount acquired from the two-dimensional image data and used to estimate the occupancy state. The above-mentioned temporal fusion can be performed, for example, by using the method disclosed in “A survey on occupancy perception for autonomous driving: The information fusion perspective”, Huaiyuan Xu, Junliang Chen, Shiyu Meng, Yi Wang, and Lap-Pui Chau, arXiv: 2405.05173, 2024.

The document of “A survey on occupancy perception for autonomous driving: The information fusion perspective” is incorporated herein by reference.

According to the device 1 of the sixth embodiment described above, the occupancy state estimation unit 120 estimates the occupancy state by the OP using the two-dimensional image data and the feature amounts extracted from the three-dimensional point group data and corrected by the Temporal Fusion, thereby improving the estimation accuracy of the occupancy state of an object compared to a configuration that does not use the Temporal Fusion. In particular, the accuracy of estimating an object that is temporarily hidden by another object can be improved.

### G. Seventh Embodiment

The device 1 of the seventh embodiment differs from the device 1 of the first embodiment in that the occupancy state estimation unit 120 estimates the occupancy state using the three-dimensional feature amounts extracted and corrected from the two-dimensional image data. The configuration of the device 1 of the seventh embodiment that is not specifically described below is the same as that of the device 1 of the first embodiment. The device 1 of the seventh embodiment may be used in combination with the device 1 of the second to sixth embodiments.

The occupancy state estimation unit 120 corrects the three-dimensional feature amount acquired from the two-dimensional image data using at least one of the position and attitude of the camera. Below, a configuration that uses both the position and attitude of the camera will be described. The position and attitude of the camera may change due to aging and other factors. In this embodiment, the three-dimensional feature amounts that take such changes into consideration are used. Specifically, the initial position and attitude of the camera are stored in advance in the memory 200, and the initial position and attitude of the camera are compared with the current position and attitude. The current position and attitude of the camera can be detected by using, for example, the VIO described in the second embodiment. The occupancy state estimation unit 120 corrects the three-dimensional feature amounts using the differences in the camera positions and attitudes acquired as a result of the comparison. Specifically, the correction can be performed by converting the differences in the positions and attitudes of the camera into the rotation and movement of the camera, and using, for example, expression (5) shown in FIG. 4 described in the sixth embodiment. The three-dimensional feature amounts corrected in this way are integrated with the three-dimensional feature amounts acquired from the three-dimensional point group data, as described in the first embodiment, and are used to estimate the occupancy state.

According to the device 1 of the seventh embodiment described above, the occupancy state estimation unit 120 estimates the occupancy state through the OP using the feature amounts extracted from the two-dimensional image data and corrected using at least one of the camera position and attitude, and the feature amounts extracted from the three-dimensional point group data. Therefore, compared to a configuration in which the feature amounts extracted from the two-dimensional image data are not corrected, it is possible to suppress a decrease in estimation accuracy due to deviations in the camera position and attitude.

### H. Other Embodiments

(H1) In each of the above embodiments, the device 1 is mounted on the vehicle 50, but the present embodiments are not limited to this feature. The device 1 may be mounted on any mobile body. The mobile body is, for example, a ship, an airplane, a so-called flying car, or the like.

(H2) In each of the above embodiments, the point group output unit 110 converts the feature points of an object in the two-dimensional image data into the feature points in the three-dimensional space using the VO, but the present embodiments are not limited to this feature. The point group output unit 110 may use the VO to convert the feature lines of an object in the two-dimensional image data into the feature lines in the three-dimensional space. That is, the point group output unit 110 may output the feature lines of the object in the three-dimensional space. The conversion can be performed using, for example, the method disclosed in “PI-vins: Realtime monocular visual-inertial slam with point and line”, Q. Fu, J. Wang, H. Yu, I. Ali, F. Guo, and H. Zhang, ArXiv, vol. abs/2009.07462, 2020.

The document of “PI-vins: Realtime monocular visual-inertial slam with point and line features” is incorporated herein by reference.

The occupancy state estimation unit 120 may estimate the occupancy state using the feature lines in addition to the two-dimensional image data and the three-dimensional point group data. The feature lines are used to extract the feature amounts.

(H3) The device 1 and the technique according to the present disclosure may be achieved by a dedicated computer provided by constituting a processor and a memory programmed to execute one or more functions embodied by a computer program. Alternatively, the device 1 and the technique thereof according to the present disclosure may be achieved by a dedicated computer provided by constituting a processor with one or more dedicated hardware logic circuits. Alternatively, the device 1 and the technique according to the present disclosure may be achieved using one or more dedicated computers constituted by a combination of the processor and the memory programmed to execute one or more functions and the processor with one or more hardware logic circuits. The computer program may also be stored on a computer-readable and non-transitory tangible storage medium as an instruction executed by a computer.

The present disclosure should not be limited to the embodiments described above, and various other embodiments may be implemented without departing from the scope of the present disclosure. For example, the technical features in the embodiment corresponding to the technical features in the form described in the summary may be used to solve some or all of the above-described problems, or to provide one of the above-described effects. In order to achieve a part or all, replacement or combination can be appropriately performed. Also, some of the technical features may be omitted as appropriate. The present disclosure can be realized in the form of, for example, a method for estimating an occupancy state, a computer program for implementing such a method, a non-transitory storage medium on which such a computer program is stored, and the like.

The present disclosure may be realized, for example, in the following forms.

### (Feature 1)

A device is mounted on a mobile body and estimates an occupancy state of a surrounding object in three-dimensional space. The mobile body has a camera that captures an image of surroundings of the mobile body and outputs two-dimensional image data. The device includes: a point group output unit that uses the two-dimensional image data to output three-dimensional point group data of the surrounding object in the three-dimensional space by Visual Odometry; and an occupancy state estimation unit that estimates the occupancy state by occupancy prediction using the two-dimensional image data and the three-dimensional point group data.

### (Feature 2)

In the device according to feature 1, the mobile body further includes an inertial measurement device that outputs at least one of an angle, angular velocity, and acceleration of the mobile body. The point group output unit further uses at least one of the angle, angular velocity, and acceleration of the mobile body to output the three-dimensional point group data by Visual Inertial Odometry.

### (Feature 3)

In the device according to feature 2, the mobile body further includes a wheel speed sensor that outputs a wheel speed of the mobile body. The point group output unit further uses the wheel speed of the mobile body to output the three-dimensional point group data by Visual Inertial Wheel Odometry.

### (Feature 4)

In the device according to feature 2 or 3, the mobile body further includes a Global Navigation Satellite System that outputs position information relating to a position of the mobile body. The point group output unit further uses the position information of the mobile body to output the three-dimensional point group data by GNSS-Aided Visual Inertial Odometry.

(feature 5)

In the device according to any one of features 1 to 4, the occupancy state estimation unit estimates the occupancy state by the Occupancy Prediction further using a map feature amount extracted from map information.

### (Feature 6)

In the device according to any one of features 1 to 5, the occupancy state estimation unit estimates the occupancy state by the Occupancy Prediction using the two-dimensional image data and a feature amount extracted from the three-dimensional point group data and corrected by Temporal Fusion.

### (Feature 7)

In the device according to any one of features 1 to 6, the occupancy state estimation unit estimates the occupancy state by the Occupancy Prediction using a feature amount extracted from the two-dimensional image data and corrected using at least one of the position and attitude of the camera, and a feature amount extracted from the three-dimensional point group data.

### (Feature 8)

In the device according to any one of features 1 to 7, the point group output unit further outputs a feature line of the surrounding object in the three-dimensional space by the Visual Odometry using the two-dimensional image data. The occupancy state estimation unit estimates the occupancy state by the Occupancy Prediction using the two-dimensional image data, the three-dimensional point group data, and the feature line.

### (Feature 9)

A method for estimating an occupancy state of a surrounding object in a three-dimensional space around a mobile body, includes: outputting two-dimensional image data acquired by capturing an image of surroundings of the mobile body; using the two-dimensional image data to output three-dimensional point group data of the surrounding object in the three-dimensional space by Visual Odometry; and estimating the occupancy state by occupancy prediction using the two-dimensional image data and the three-dimensional point group data.

Reference numeral 1 indicates a device, reference numeral 50 indicates a vehicle, reference numeral 100 indicates a processor, reference numeral 110 indicates a point group output unit, reference numeral 120 indicates an occupancy state estimation unit, reference numeral 200 indicates a memory, reference numeral 300 indicates an input/output interface, reference numeral 400 indicates an internal bus, each of reference numerals 500A, 500B, 500C, 500D, 500E, and 500F indicate a camera, and reference numeral 500 indicates a camera group.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A device mounted on a mobile body for estimating an occupancy state of a surrounding object in three-dimensional space,
the mobile body having a camera that captures an image of surroundings of the mobile body and outputs two-dimensional image data,
the device comprising:
at least one processor with a memory, wherein:
the at least one processor with the memory is configured to cause the device to execute:
using the two-dimensional image data to output three-dimensional point group data of the surrounding object in the three-dimensional space by Visual Odometry; and
estimating the occupancy state by occupancy prediction using the two-dimensional image data and the three-dimensional point group data.

2. The device according to claim 1, wherein:
the at least one processor with the memory is configured to cause the device to execute: using the two-dimensional image data to output three-dimensional point group data of the surrounding object in the three-dimensional space by Visual Odometry as a point group output unit; and
the at least one processor with the memory is configured to cause the device to execute: estimating the occupancy state by occupancy prediction using the two-dimensional image data and the three-dimensional point group data an occupancy state estimation unit.

3. The device according to claim 2, wherein:
the mobile body further includes an inertial measurement device that outputs at least one of an angle, angular velocity, and acceleration of the mobile body; and
the point group output unit further uses at least one of the angle, angular velocity, and acceleration of the mobile body to output the three-dimensional point group data by Visual Inertial Odometry.

4. The device according to claim 3, wherein:
the mobile body further includes a wheel speed sensor that outputs a wheel speed of the mobile body; and
the point group output unit further uses the wheel speed of the mobile body to output the three-dimensional point group data by Visual Inertial Wheel Odometry.

5. The device according to claim 3, wherein:
the mobile body further includes a Global Navigation Satellite System that outputs position information relating to a position of the mobile body; and
the point group output unit further uses the position information of the mobile body to output the three-dimensional point group data by GNSS-Aided Visual Inertial Odometry.

6. The device according to claim 5, wherein:
the occupancy state estimation unit estimates the occupancy state by the occupancy prediction further using a map feature amount extracted from map information.

7. The device according to claim 3, wherein:
the occupancy state estimation unit estimates the occupancy state by the occupancy prediction using the two-dimensional image data and a feature amount extracted from the three-dimensional point group data and corrected by Temporal Fusion.

8. The device according to claim 3, wherein:
the occupancy state estimation unit estimates the occupancy state by the occupancy prediction using a feature amount extracted from the two-dimensional image data and corrected using at least one of position and attitude of the camera, and a feature amount extracted from the three-dimensional point group data.

9. The device according to claim 2, wherein:
the point group output unit further outputs a feature line of the surrounding object in the three-dimensional space by the Visual Odometry using the two-dimensional image data; and
the occupancy state estimation unit estimates the occupancy state by the occupancy prediction using the two-dimensional image data, the three-dimensional point group data, and the feature line.

10. The device according to claim 1, wherein:
the occupancy state estimated in the estimating of the occupancy state is used for drive support of the mobile body including collision prediction of the mobile body.

11. A method for estimating an occupancy state of a surrounding object in a three-dimensional space around a mobile body,
the method comprising:
outputting two-dimensional image data acquired by capturing an image of surroundings of the mobile body;
using the two-dimensional image data to output three-dimensional point group data of the surrounding object in the three-dimensional space by Visual Odometry; and
estimating the occupancy state by occupancy prediction using the two-dimensional image data and the three-dimensional point group data.

12. The method according to claim 11, wherein:
the occupancy state estimated in the estimating of the occupancy state is used for drive support of the mobile body including collision prediction of the mobile body.

13. A non-transitory computer readable storage medium comprising instructions being executed by a computer, the instructions including a computer-implemented method for estimating an occupancy state of a surrounding object in a three-dimensional space around a mobile body,
the instructions including:
outputting two-dimensional image data acquired by capturing an image of surroundings of the mobile body;
using the two-dimensional image data to output three-dimensional point group data of the surrounding object in the three-dimensional space by Visual Odometry; and
estimating the occupancy state by occupancy prediction using the two-dimensional image data and the three-dimensional point group data.

14. The non-transitory computer readable storage medium according to claim 13, wherein:
the occupancy state estimated in the estimating of the occupancy state is used for drive support of the mobile body including collision prediction of the mobile body.
